(19) United States
(12) Patent Application Publication
(10) Pub. No.: US 2023/0043554 A1
(43) Pub. Date: Feb. 9, 2023

(54) NEGATIVE ELECTRODE MATERIAL, ELECTROCHEMICAL DEVICE, AND ELECTRONIC DEVICE

(71) Applicants: Ningde Amperex Technology Limited, Ningde (CN); Dongguan Amperex Technology Limited, Dongguan (CN)

(72) Inventors: Chenxi JIANG, Ningde (CN); Yafei ZHANG, Ningde (CN); Yuansen XIE, Ningde (CN); Hongming YU, Ningde (CN)

(73) Assignees: Ningde Amperex Technology Limited, Ningde (CN); Dongguan Amperex Technology Limited, Dongguan (CN)

(21) Appl. No.: 17/951,375

(22) Filed: Sep. 23, 2022

Related U.S. Application Data
(63) Continuation of application No. PCT/CN2020/081183, filed on Mar. 25, 2020.

(51) Int. Cl. H01M 4/38; H01M 10/052

(52) U.S. Cl. CPC H01M 4/386; H01M 10/052; H01M 2004/027

(57) ABSTRACT

A negative electrode material includes silicon composite particles. The silicon composite particles include amorphous silicon particles and a buffer phase. The amorphous silicon particles are dispersed in the buffer phase. A non-uniformity of the amorphous silicon particles dispersed in the buffer phase is less than or equal to 30%. Also, an electronic device including the negative electrode material.

### CROSS-REFERENCE TO RELATED APPLICATION

The present application is a continuation application of PCT Patent Application Serial No. PCT/CN2020/081183, filed on Mar. 25, 2020, the content of which is incorporated by reference in its entirety.

### TECHNICAL FIELD

This application relates to the technical field of energy storage, and in particular, to a negative electrode material, an electrochemical device containing the negative electrode material, and an electronic device containing the electrochemical device.

### BACKGROUND

In recent years, with the rapid development of products such as mobile devices and electric vehicles, electrochemical devices of a high volumetric energy density have attracted much attention and research. Silicon-based materials are characterized by an extremely high capacity and a relatively low delithiation/lithiation potential, and are ideal negative electrode materials for next-generation electrochemical devices of a high volumetric energy density.

The volumetric energy density of an electrochemical device=(capacity of the electrochemical device×discharge plateau)/(length×width×thickness). Understandably, in a case that a material system (the capacity and discharge plateau of electrochemical devices are consistent) and the length and width dimensions are identical between electrochemical devices, a factor affecting the volumetric energy density of the electrochemical devices is the thickness of the electrochemical devices. The thicker the electrochemical device, the lower the volumetric energy density of the electrochemical device. However, after the electrochemical device is subjected to charge-and-discharge cycles, electrode plates expand to some extent, resulting in an increase in the thickness of the electrochemical device. For example, using a commercially available electrochemical device as an example in which a positive electrode material is lithium cobalt oxide and a negative electrode material is graphite, the thickness of the electrochemical device increases by approximately 10% upon completion of 500 charge-and-discharge cycles after the electrochemical device is manufactured (graded). A majority of the thickness increase is caused by the expansion of the negative electrode plate. Especially, for a lithium battery using a silicon-based material as the negative electrode material, the negative electrode plate expands to a greater extent after 500 charge-and-discharge cycles.

### SUMMARY

In view of the situation above, it is necessary to provide a silicon negative electrode material that reduces thickness expansion of a negative electrode plate in a charge-and-discharge process, so as to solve the foregoing problem.

As discovered in investigation by the inventor of this application, in a negative electrode material containing a silicon material, silicon composite particles are formed by dispersing amorphous silicon particles in a buffer phase, and a non-uniformity of the amorphous silicon particles dispersed in the buffer phase is controlled, thereby greatly suppressing cracking of composite particles caused by anisotropy of cycle expansion of the silicon particles while achieving a relatively high energy density, and in turn, alleviating the cycle expansion of the negative electrode material.

Specifically, in order to solve the technical problem above, the following solutions are provided.

A negative electrode material is disclosed. The negative electrode material includes silicon composite particles. The silicon composite particles include amorphous silicon particles and a buffer phase. The amorphous silicon particles are dispersed in the buffer phase. A non-uniformity of the amorphous silicon particles dispersed in the buffer phase is less than or equal to 30%.

By controlling the non-uniformity of the amorphous silicon particles dispersed in the buffer phase to fall within a specified range, this application can improve consistency of the silicon composite particles during cycle expansion, disperse an expansion stress of the silicon composite particles greatly, and avoid particle cracking caused by anisotropy of cycle expansion of the silicon composite particles, thereby reducing the expansion of the negative electrode material during cycles and alleviating thickness growth of the negative electrode plate.

In some embodiments of this application, a non-uniformity of the amorphous silicon particles dispersed in the buffer phase is less than or equal to 15%. Through a large number of tests, studies, and verifications, the inventor of this application finds that the non-uniformity of the amorphous silicon particles dispersed in the buffer phase can be controlled to be not greater than 15% to further improve the consistency of the silicon composite particles during cycle expansion, and further reduce the expansion of the negative electrode material during cycles.

In some embodiments of this application, a sphericity of the silicon composite particles is greater than or equal to 0.50. Through tests, studies, and verifications, the inventor of this application among others finds that the sphericity of the silicon composite particles in the negative electrode material is high. During cyclic expansion of the silicon composite particles, the amount of expansion can keep consistent in all directions, thereby preventing the silicon composite particles from rotating or rearrangement, and further reducing the thickness expansion of the negative electrode plate.

In some embodiments of this application, the specific surface area of the negative electrode material is less than or equal to 5 m²/g. Through experimental studies and verifications, the inventor of this application finds that the specific surface area of the negative electrode material affects a reaction area between the negative electrode material and an electrolyte, thereby affecting by-product formation and a cycle life. By-products increase the thickness of the negative electrode plate, and reduce the energy density of the electrochemical device. The specific surface area of the negative electrode material can be controlled to fall within a specified range to help reduce side reactions, and further increase the energy density and cycle life.

In some embodiments of this application, a particle size of the negative electrode material satisfies D₉₀−D₁₀≤15 μm. The particle size distribution range of the negative electrode material is relatively narrow. During expansion of the silicon composite particles, the amount of volume expansion is basically identical between the silicon composite particles, without causing rearrangement of the silicon composite particles, thereby further alleviating the cycle thickness expansion of the negative electrode plate.

In some embodiments of this application, the buffer phase includes at least one of elements of carbon, oxygen, silicon, iron, titanium, aluminum, or cadmium.

In some embodiments of this application, the buffer phase includes at least one of silicon monoxide or silicon dioxide.

In some embodiments of this application, the silicon composite particles further includes a conductive agent. The conductive agent is dispersed in the buffer phase. The conductive agent is configured to improve conductivity of the silicon composite particles. The conductive agent can be dispersed in the silicon composite particles to improve conductivity inside the silicon composite particles, and in turn, improve electrical performance of the negative electrode material.

This application further provides an electrochemical device. The electrochemical device includes a negative electrode plate. The negative electrode plate includes a negative active material layer, and the negative active material layer includes the negative electrode material. The electrochemical device achieves a relatively low cycle expansion thickness, relatively high cycle performance, and a long service life. This application further provides an electronic device. The electronic device includes the electrochemical device.

### BRIEF DESCRIPTION OF DRAWINGS

FIG. 1 is a schematic structural diagram of a negative electrode material according to an embodiment of this application;

FIG. 2 is a schematic diagram of energy dispersive X-ray spectroscopy for silicon composite particles in a negative electrode material;

FIG. 3 is a schematic structural diagram of an electrochemical device according to an embodiment of this application; and

FIG. 4 is a schematic structural diagram of an electronic device according to an embodiment of this application.

Reference numerals of main components:

| | |
|---|---|
| Negative electrode material | 100 |
| Silicon composite particles | 10 |
| Amorphous silicon particles | 12 |
| Buffer phase | 14 |
| Conductive agent | 16 |
| Electrochemical device | 200 |
| Negative electrode plate | 22 |
| Positive electrode plate | 24 |
| Separator | 26 |
| Electrolyte | 28 |
| Electronic device | 300 |

This application is further described below with reference to the following specific embodiments and the foregoing drawings.

### DETAILED DESCRIPTION

To make the foregoing objectives, features, and advantages of this application more comprehensible, the following describes this application in detail with reference to drawings and specific embodiments. It needs to be noted that to the extent that no conflict occurs, the embodiments of this application and the features in the embodiments may be combined with each other. For thorough understanding of this application, many details are given below. The embodiments described herein are merely a part of rather than all of the embodiments of this application. All other embodiments derived by a person of ordinary skill in the art based on the embodiments of the present invention fall within the protection scope of the present invention.

Unless otherwise defined, all technical and scientific terms used herein have the same meanings as usually understood by a person skilled in the technical field of this application. The terms used in the specification hereof are merely intended to describe specific embodiments but are not to limit this application. The term “and/or” used herein includes any and all combinations of one or more related items preceding and following the term.

In the description herein, D₁₀ is a particle diameter of silicon composite particles 10 measured when the cumulative volume percentage of the measured particles calculated from a small-diameter side reaches 10% of the total volume of the particles in a volume-based particle size distribution; D₅₀ is a particle diameter of the silicon composite particles 10 measured when the cumulative volume percentage of the measured particles calculated from a small-diameter side reaches 50% of the total volume of the particles in a volume-based particle size distribution; and D₉₀ is a particle diameter of the silicon composite particles 10 measured when the cumulative volume percentage of the measured particles calculated from a small-diameter side reaches 90% of the total volume of the particles in a volume-based particle size distribution.

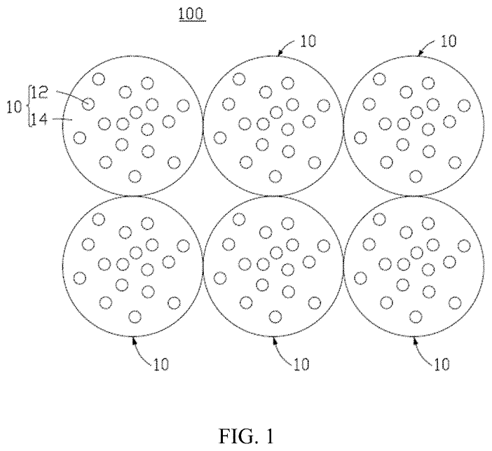

Referring to FIG. 1, this application provides a negative electrode material 100. The negative electrode material 100 includes silicon composite particles 10. The silicon composite particles 10 include amorphous silicon particles 12 and a buffer phase 14. The amorphous silicon particles 12 are dispersed in the buffer phase 14. It is defined that a non-uniformity of the amorphous silicon particles 12 dispersed in the buffer phase 14 is N, and N is less than or equal to 30%.

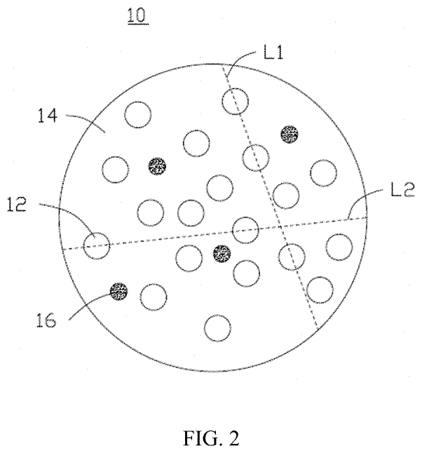

The method for calculating the non-uniformity N is: performing line scanning on the silicon element in any internal plane of the silicon composite particles 10 by using energy dispersive X-ray spectroscopy (EDS) to obtain a line, and using a ratio of an integrated peak area to a line scan distance to represent the content of amorphous silicon particles 12 of this line, where the line scan distance is greater than ½D₅₀. Referring to FIG. 2, the content of amorphous silicon particles 12 of any line scan L1 is defined as X, and the content of amorphous silicon particles 12 of any other line scan L2 is defined as Y. A formula for calculating the non-uniformity N of the amorphous silicon particles 12 dispersed in the buffer phase 14 is:

N=Max|X−Y|/(X+Y).

The silicon composite particles 10 according to this application include amorphous silicon particles 12 and a buffer phase 14. By contrast, in a case of lithiation of crystalline silicon particles, the (110) crystal plane expands faster than crystal planes in other directions, thereby being prone to cause lithiation-induced expansion of the negative electrode material 100 and cracking of the negative electrode material 100. The amorphous silicon particles 12 adopted in this application can maintain isotropy of expansion of the negative electrode material 100, thereby preventing the negative electrode material 100 from expanding and cracking during lithiation, and reducing the cycle expansion thickness of the negative electrode plate.

Moreover, the non-uniformity of the amorphous silicon particles 12 dispersed in the buffer phase 14 is relatively low, thereby further improving the consistency in an expansion process of the amorphous silicon particles 12, further avoiding cracking of the negative electrode material 100 caused by anisotropy of the expansion of the amorphous silicon particles 12, and further reducing the cycle expansion thickness of the negative electrode plate.

Optionally, the non-uniformity of the amorphous silicon particles 12 dispersed in the buffer phase 14 is less than or equal to 15%. By controlling the non-uniformity of the amorphous silicon particles 12 dispersed in the buffer phase 14 to be less than or equal to 15%, this application can greatly improve the consistency in the cycle expansion process of the amorphous silicon particles 12, further avoid cracking of the negative electrode material 100, and further reduce the cycle expansion thickness of the negative electrode plate.

Further, a sphericity of the silicon composite particles 10 is greater than or equal to 0.50. The sphericity is a ratio of a surface area of a sphere volumetrically identical to a silicon composite particle 10 to a surface area of the silicon composite particle 10. The surface area does not include the surface area generated by pores inside the silicon composite particle 10.

A conventional negative electrode material is prone to expand in a plurality of charge-and-discharge processes. If the sphericity of a particle is less than 0.50, the particle is irregular in shape, and the particle is in a packed state before charging. In a charging process, lithium ions are intercalated into the negative electrode material (known as a lithiation process), and the particle expands. Due to the irregular shape of the particle, the amount of expansion in different directions differs during the expansion, resulting in mutual extrusion between particles. Some particles are rotated or rearranged. In a discharge process, lithium ions are deintercalated from the negative electrode material (known as a delithiation process), and the particles shrink. Due to the irregular shape and pointedness of the particles, a steric hindrance exists between the particles, and the particles are unable be restored to initial positions that are arranged before the charging. The porosity keeps increasing. A packing density of the negative electrode material 100 on the negative electrode plate decreases, thereby increasing the thickness of the negative electrode plate.

In this application, the silicon composite particles 10 are granulated to form particles that are spherical. Due to the high sphericity of the silicon composite particles 10, the silicon composite particles 10 are highly regular in shape and expand by close amounts in all directions. Therefore, in a charging process, the silicon composite particles 10 expand evenly and are not rearranged or rotated due to inconsistent amounts of expansion of the silicon composite particles 10. Without steric hindrance between the silicon composite particles 10, the silicon composite particles 10 can well restored to the same positions as those before the charging, and the thickness expansion of the negative electrode plate is relatively small.

In an embodiment of this application, the Brunauer-Emmett-Teller (BET) specific surface area of the negative electrode material 100 is less than or equal to 5 m²/g. The BET specific surface area of the negative electrode material 100 affects a contact area between the negative electrode material 100 and the electrolyte. A relatively large BET specific surface area improves reactivity of the negative electrode material 100, and also increases a probability of side reactions. By-products arising from the side reactions increase the thickness of the negative electrode plate. Therefore, controlling the BET specific surface area of the negative electrode material 100 to fall within 5 m²/g helps to reduce side reactions. In this embodiment, the BET specific surface area of the negative electrode material 100 may be controlled by controlling the number of small and medium-sized particles in the negative electrode material 100.

In an embodiment of this application, a particle size of the negative electrode material 100 satisfies D₉₀−D₁₀≤15 μm. Therefore, the particle size distribution range of the negative electrode material 100 is relatively narrow. When the particles that are sharply different in diameter are packed together, in a charge-and-discharge process, a particle of a larger diameter expands to a greater extent in volume, and a particle of a smaller diameter expands to a lesser extent in volume, thereby leading to particle rearrangement. After discharging, the particles can hardly return to the initial positions, resulting in an increase in the thickness of the negative electrode plate. In this application, the particle size distribution of the negative electrode material 100 is controlled to fall within a specified range, so that the particles of the negative electrode material 100 can return to the initial positions after discharging, thereby avoiding increase in the thickness of the negative electrode plate.

In this embodiment, the buffer phase 14 includes at least one of elements of carbon, oxygen, silicon, iron, titanium, aluminum, or cadmium. To be specific, the buffer phase 14 includes a simple substance, a compound, or a mixture formed of carbon, oxygen, silicon, iron, titanium, aluminum, cadmium, and the like, for example, a carbon material, silicon monoxide, or silicon dioxide. The buffer phase 14 exerts a buffering effect in the expansion process of the amorphous silicon particles 12, thereby further alleviating the expansion of the negative electrode material 100 in the cycle process.

In an embodiment of this application, the silicon composite particles 10 further include a conductive agent 16 such as a carbon-containing conductive agent (conductive carbon black, carbon nanotubes, graphene, and the like). The conductive agent 16 is dispersed in the buffer phase 14. The conductive agent 16 is configured to improve conductivity inside the silicon composite particles 10, and in turn, improve electrical performance of the negative electrode material 100.

This application further provides an electrochemical device 200. The electrochemical device 200 according to this application includes any device capable of electrochemical reactions. Specifically, the electrochemical device 200 includes all types of primary batteries, secondary batteries, fuel cells, and capacitors (such as supercapacitors). Optionally, the electrochemical device 200 may be a lithium secondary battery, including a lithium metal secondary battery, a lithium-ion secondary battery, a lithium polymer secondary battery, and a lithium-ion polymer secondary battery.

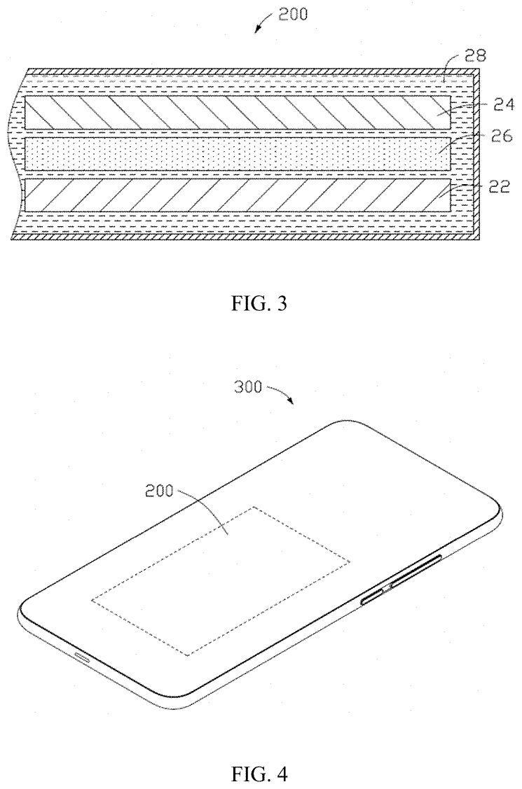

Referring to FIG. 3, in an embodiment of this application, the electrochemical device 200, such as a lithium-ion secondary battery, includes a negative electrode plate 22. The negative electrode plate 22 includes a negative active material layer (not shown in the drawing), and the negative active material layer includes the negative electrode material 100.

In an embodiment of this application, the electrochemical device 200 further includes a positive electrode plate 24, a separator 26, and an electrolyte 28. The separator 26 is located between the negative electrode plate 22 and the positive electrode plate 24. The electrolyte 28 infiltrates the negative electrode plate 22, the separator 26, and the positive electrode plate 24. The negative electrode plate 22 includes the negative electrode material 100.

In an embodiment of this application, this application provides a method for synthesizing and preparing the negative electrode material 100, including: (1) preparing amorphous silicon particles 12 by pyrolyzing a silane precursor; (2) mechanically dispersing the amorphous silicon particles 12 in asphalt; (3) calcining to form silicon composite particles 10; (4) spherically granulating the silicon composite particles 10; and (5) screening to obtain the silicon composite particles 10 that meet the particle size requirements. In some embodiments, a conductive agent 16 may be further added in the process of preparing the negative electrode material 100. The conductive agent 16 may be dispersed in the buffer phase 14, and further, may be evenly distributed in the buffer phase 14. Understandably, a person skilled in the art may select a conventional conductive substance as the conductive agent 16 as required without limitation.

In an embodiment of this application, the negative electrode material 100, the conductive material, the binder, and the solvent are mixed at a specified ratio, coated onto the negative current collector, and dried to form a negative active material layer. In some embodiments, the negative current collector may be, but without being limited to, a copper foil or a nickel foil. Understandably, a person skilled in the art may select a conventional conductive material, binder, and solvent as required without limitation.

In an embodiment of this application, the positive electrode material, the conductive material, the binder, and the solvent are mixed at a specified ratio, coated onto the positive current collector, and dried to form a positive active material layer. In some embodiments, the positive current collector may be, but without being limited to, an aluminum foil or a nickel foil. Understandably, a person skilled in the art may select a conventional conductive material, binder, and solvent as required without limitation.

In an embodiment of this application, the positive electrode plate 24 includes a positive active material layer. The positive active material layer includes a positive electrode material. The positive electrode material may include one or more of lithium cobalt oxide, lithium nickel cobalt manganese oxide, lithium nickel cobalt aluminum oxide, lithium manganese oxide, lithium iron manganese phosphate, lithium vanadium phosphate, lithium vanadyl phosphate, lithium iron phosphate, lithium titanium oxide, or a lithium-rich manganese-based material.

In an embodiment of this application, the separator 26 includes, but is not limited to, at least one of polyethylene, polypropylene, polyethylene terephthalate, polyimide, and aramid. For example, the polyethylene includes a component selected from at least one of high-density polyethylene, low-density polyethylene, and ultra-high-molecular-weight polyethylene. Especially, the polyethylene and the polypropylene are highly effective in preventing short circuits, and improve stability of the battery through a turn-off effect.

In an embodiment of this application, the electrolyte 28 may be one or more of a gel electrolyte, a solid-state electrolyte, or a liquid-state electrolyte. The electrolyte 28 includes a lithium salt and a nonaqueous solvent.

In an embodiment of this application, the lithium salt is one or more selected from LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, and lithium difluoroborate. For example, the lithium salt is LiPF₆ because it provides a high ionic conductivity and improves cycle characteristics.

The nonaqueous solvent may be a carbonate compound, a carboxylate compound, an ether compound, another organic solvent, or any combination thereof.

The carbonate compound may be a chain carbonate compound, a cyclic carbonate compound, a fluorocarbonate compound, or any combination thereof.

Examples of the other organic solvent are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, and any combination thereof.

In an embodiment of this application, the nonaqueous solvent is selected from groups that each include ethylene carbonate, propylene carbonate, diethyl carbonate, dimethyl carbonate, ethyl methyl carbonate, propylene carbonate, methyl acetate, ethyl propionate, or fluoroethylene carbonate, or any combination thereof.

Understandably, the methods for preparing the positive electrode plate 24, the separator 26, the electrolyte 28, and the electrochemical device 200 in embodiments of this application may be, but without being limited to, any appropriate conventional methods in the art selected according to specific requirements, without departing from the spirit of this application. In an implementation solution of the method for manufacturing an electrochemical device 200, the method for preparing a lithium-ion battery includes: winding, folding, or stacking the negative electrode plate 22, the separator 26, and the positive electrode plate 24 in the foregoing embodiments sequentially to form an electrode assembly; putting the electrode assembly into, for example, an aluminum plastic film, and injecting an electrolyte 28; and then performing steps such as vacuum packaging, static standing, formation, and shaping to obtain a lithium-ion battery.

This application further provides an electronic device 300. The electronic device 300 includes the electrochemical device 200. The electronic device 300 may be a consumer electronic products (such as a mobile communication device, a tablet computer, a notebook computer, or a wearable device), a power tool, an unmanned aerial vehicle, an energy storage device, a power device, or the like. Referring to FIG. 4, in an embodiment, the electronic device 300 is a mobile communication device.

The following describes this application with reference to specific embodiments.

### Comparative Embodiment 1

Pyrolyzing a silane precursor to prepare amorphous silicon particles. Dispersing the amorphous silicon particles in asphalt, and then calcining to form silicon composite particles. In the foregoing process, adjusting a dispersion uniformity of the amorphous silicon particles in the asphalt by controlling mechanical dispersion conditions; and controlling the ratio of the amorphous silicon particles to the asphalt, so that the gram capacity of the prepared negative electrode material is 800 mAh/g. Subsequently, granulating by ball milling, controlling the ball milling conditions, adjusting the sphericity of the silicon-carbon composite particles, and finally screening to obtain the negative electrode material of an appropriate particle size. Removing fine powder to finally obtain the negative electrode material that includes the amorphous particles and the buffer phase in which the amorphous particles are dispersed, where the buffer phase is a carbon material, the non-uniformity of the amorphous silicon particles in the buffer phase is 36.3%, the sphericity of the silicon composite particles is 0.32, the negative electrode material satisfies D₉₀−D₁₀=17.3 μm, and the BET specific surface area of the negative electrode material is 2.6 m²/g.

Mixing the negative electrode material, polyacrylic acid (Polyacrylic Acid, PAA), conductive carbon black, and sodium carboxymethyl cellulose (Sodium Carboxymethyl Cellulose, CMC) at a mass ratio of 0.87: 0.1: 0.02: 0.01 to form a solution in which an appropriate amount of solvent is added, so as to make a negative slurry. Coating a 10 μm-thick copper foil with the negative slurry, and then performing cold pressing. The final coating weight is 2.0 g/cm², and the cold-pressed density is 1.2 g/cm³. Assembling a metallic lithium sheet as a counter electrode with the negative electrode plate and the electrolyte to form a 2032-type button battery (20 mm in diameter, 3.2 mm in thickness, in which the dimension of the negative electrode plate is 1.54 cm²), where the solvent in the electrolyte is formulated by mixing ethylene carbonate (Ethylene Carbonate, EC), propylene carbonate (Propylene Carbonate, PC), ethyl methyl carbonate (Ethyl Methyl Carbonate, EMC), and fluoroethylene carbonate (Fluoroethylene carbonate, FEC) at a mass ratio of 3: 3: 2: 2, and the electrolyte is 1 mol/L LiPF₆. Leaving the button battery to stand in an 45° C. environment for 48 hours upon completion of assembling the button battery, so that the electrolyte infiltrates the negative electrode plate and the metal lithium sheet. Subsequently, performing charge and discharge in the following process: discharging the battery at a current of 1 mA until the voltage reaches 5 mV, discharging the battery at a current of 0.1 mA until the voltage reaches 5 mV, and then charging the battery at a current of 1 mA until the voltage reaches 1.5 V. Repeating the foregoing process for 100 cycles. Subsequently, testing the density of the negative electrode plate, the capacity retention rate, and the expansion rate of the negative electrode plate.

### Density of the Negative Electrode Plate

Weighing the coating weight (Wg/cm²) of the negative electrode plate, measuring the thickness (T1 μm) of the negative electrode plate (including the negative current collector) by using a micrometer, measuring the thickness (T2 μm) of the negative current collector, and then calculating the density according to: density of the negative electrode plate=1000×W/(T1−T2).

### Capacity Retention Rate

Measuring a delithiation capacity A after the battery undergoes a first cycle according to the foregoing charge-and-discharge process, measuring a delithiation capacity B after the battery undergoes n cycles, and calculating according to: capacity retention rate=B/A×100%.

### Expansion Rate of the Negative Electrode Plate

Expansion rate of negative electrode plate after n cycles=(density of negative electrode plate during cold pressing/density of negative electrode plate after n cycles−1)×100%.

### Comparative Embodiment 2

Different from Comparative Embodiment 1 in: the non-uniformity of the amorphous silicon particles in the buffer phase is 35.2%, the sphericity of the silicon composite particles is 0.30, the negative electrode material satisfies D₉₀−D₁₀−12.2 μm, and the BET specific surface area of the negative electrode material is 2.7 m²/g.

### Comparative Embodiment 3

Different from Comparative Embodiment 1 in: the non-uniformity of the amorphous silicon particles in the buffer phase is 35.9%, the sphericity of the silicon composite particles is 0.35, the negative electrode material satisfies D₉₀−D₁₀=8.7 μm, and the BET specific surface area of the negative electrode material is 2.6 m²/g.

### Comparative Embodiment 4

Different from Comparative Embodiment 1 in: the non-uniformity of the amorphous silicon particles in the buffer phase is 36.8%, the sphericity of the silicon composite particles is 0.66, the negative electrode material satisfies D₉₀−D₁₀=16.9 μm, and the BET specific surface area of the negative electrode material is 2.5 m²/g.

### Comparative Embodiment 5

Different from Comparative Embodiment 1 in: the non-uniformity of the amorphous silicon particles in the buffer phase is 34.6%, the sphericity of the silicon composite particles is 0.62, the negative electrode material satisfies D₉₀−D₁₀=12.7 μm, and the BET specific surface area of the negative electrode material is 2.6 m²/g.

### Comparative Embodiment 6

Different from Comparative Embodiment 1 in: the non-uniformity of the amorphous silicon particles in the buffer phase is 35.4%, the sphericity of the silicon composite particles is 0.63, the negative electrode material satisfies D₉₀−D₁₀=8.4 μm, and the BET specific surface area of the negative electrode material is 2.7 m²/g.

### Comparative Embodiment 7

Different from Comparative Embodiment 1 in: the non-uniformity of the amorphous silicon particles in the buffer phase is 34.4%, the sphericity of the silicon composite particles is 0.88, the negative electrode material satisfies D₉₀−D₁₀=18.0 μm, and the BET specific surface area of the negative electrode material is 2.5 m²/g.

### Comparative Embodiment 8

Different from Comparative Embodiment 1 in: the non-uniformity of the amorphous silicon particles in the buffer phase is 35.8%, the sphericity of the silicon composite particles is 0.86, the negative electrode material satisfies D₉₀−D₁₀=12.0 μm, and the BET specific surface area of the negative electrode material is 2.6 m²/g.

### Comparative Embodiment 9

Different from Comparative Embodiment 1 in: the non-uniformity of the amorphous silicon particles in the buffer phase is 35.7%, the sphericity of the silicon composite particles is 0.84, the negative electrode material satisfies D₉₀−D₁₀=8.3 μm, and the BET specific surface area of the negative electrode material is 2.6 m²/g.

### Comparative Embodiment 10

Different from Comparative Embodiment 1 in: the non-uniformity of the amorphous silicon particles in the buffer phase is 24.2%, the sphericity of the silicon composite particles is 0.35, the negative electrode material satisfies D₉₀−D₁₀=16.8 μm, and the BET specific surface area of the negative electrode material is 2.5 m²/g.

### Comparative Embodiment 11

Different from Comparative Embodiment 1 in: the non-uniformity of the amorphous silicon particles in the buffer phase is 25.1%, the sphericity of the silicon composite particles is 0.31, the negative electrode material satisfies D₉₀−D₁₀=12.8 μm, and the BET specific surface area of the negative electrode material is 2.5 m²/g.

### Comparative Embodiment 12

Different from Comparative Embodiment 1 in: the non-uniformity of the amorphous silicon particles in the buffer phase is 23.3%, the sphericity of the silicon composite particles is 0.33, the negative electrode material satisfies D₉₀−D₁₀=8.6 μm, and the BET specific surface area of the negative electrode material is 2.5 m²/g.

### Comparative Embodiment 13

Different from Comparative Embodiment 1 in: the non-uniformity of the amorphous silicon particles in the buffer phase is 9.9%, the sphericity of the silicon composite particles is 0.65, the negative electrode material satisfies D₉₀−D₁₀=17.3 μm, and the BET specific surface area of the negative electrode material is 2.6 m²/g.

### Comparative Embodiment 14

Different from Comparative Embodiment 1 in: the non-uniformity of the amorphous silicon particles in the buffer phase is 10.3%, the sphericity of the silicon composite particles is 0.89, the negative electrode material satisfies D₉₀−D₁₀=17.7 μm, and the BET specific surface area of the negative electrode material is 2.5 m²/g.

### Comparative Embodiment 15

Different from Comparative Embodiment 1 in: the non-uniformity of the amorphous silicon particles in the buffer phase is 10.3%, the sphericity of the silicon composite particles is 0.83, the negative electrode material satisfies D₉₀−D₁₀=7.9 μm, and the BET specific surface area of the negative electrode material is 8.3 m²/g.

### Embodiment 1

Different from Comparative Embodiment 1 in: the non-uniformity of the amorphous silicon particles 12 in the buffer phase 14 is 25.9%, the sphericity of the silicon composite particles 10 is 0.66, the negative electrode material satisfies D₉₀−D₁₀=12.3 μm, and the BET specific surface area of the negative electrode material is 2.5 m²/g.

### Embodiment 2

Different from Comparative Embodiment 1 in: the non-uniformity of the amorphous silicon particles 12 in the buffer phase 14 is 24.3%, the sphericity of the silicon composite particles 10 is 0.85, the negative electrode material satisfies D₉₀−D₁₀=8.5 μm, and the BET specific surface area of the negative electrode material is 2.4 m²/g.

### Embodiment 3

Different from Comparative Embodiment 1 in: the non-uniformity of the amorphous silicon particles 12 in the buffer phase 14 is 26.1%, the sphericity of the silicon composite particles 10 is 0.85, the negative electrode material satisfies D₉₀−D₁₀=12.3 μm, and the BET specific surface area of the negative electrode material is 2.6 m²/g.

### Embodiment 4

Different from Comparative Embodiment 1 in: the non-uniformity of the amorphous silicon particles 12 in the buffer phase 14 is 27.4%, the sphericity of the silicon composite particles 10 is 0.88, the negative electrode material satisfies D₉₀−D₁₀=8.2 μm, and the BET specific surface area of the negative electrode material is 2.5 m²/g.

### Embodiment 5

Different from Comparative Embodiment 1 in: the non-uniformity of the amorphous silicon particles 12 in the buffer phase 14 is 10.4%, the sphericity of the silicon composite particles 10 is 0.68, the negative electrode material satisfies D₉₀−D₁₀=12.9 μm, and the BET specific surface area of the negative electrode material is 2.7 m²/g.

### Embodiment 6

Different from Comparative Embodiment 1 in: the non-uniformity of the amorphous silicon particles 12 in the buffer phase 14 is 10.8%, the sphericity of the silicon composite particles 10 is 0.62, the negative electrode material satisfies D₉₀−D₁₀=8.4 μm, and the BET specific surface area of the negative electrode material is 2.8 m²/g.

### Embodiment 7

Different from Comparative Embodiment 1 in: the non-uniformity of the amorphous silicon particles 12 in the buffer phase 14 is 12.4%, the sphericity of the silicon composite particles 10 is 0.84, the negative electrode material satisfies D₉₀−D₁₀=12.0 μm, and the BET specific surface area of the negative electrode material is 2.6 m²/g.

### Embodiment 8

Different from Comparative Embodiment 1 in: the non-uniformity of the amorphous silicon particles 12 in the buffer phase 14 is 11.4%, the sphericity of the silicon composite particles 10 is 0.89, the negative electrode material satisfies D₉₀−D₁₀=8.5 μm, and the BET specific surface area of the negative electrode material is 2.6 m²/g.

### Embodiment 9

Different from Comparative Embodiment 1 in: the non-uniformity of the amorphous silicon particles 12 in the buffer phase 14 is 12.4%, the sphericity of the silicon composite particles 10 is 0.82, the negative electrode material satisfies D₉₀−D₁₀=8.4 μm, and the BET specific surface area of the negative electrode material is 4.3 m²/g.

Referring to Table 1, Table 1 shows physical parameters and performance test results of the negative electrode materials 100 prepared in Comparative Embodiments 1 to 15 and Embodiments 1 to 9.

TABLE 1

| | | | | BET specific | Capacity | Density of negative | Expansion rate |
|---|---|---|---|---|---|---|---|
| | Non- | | D₉₀-D₁₀ | surface area | retention | electrode plate | of the negative |
| | uniformity | Sphericity | (μm) | (m²/g) | rate | (g/cm³) | electrode plate |
| Comparative | 36.3% | 0.32 | 17.3 | 2.6 | 68% | 0.52 | 130.8% |
| Embodiment 1 | | | | | | | |
| Comparative | 35.2% | 0.30 | 12.2 | 2.7 | 70% | 0.56 | 114.3% |
| Embodiment 2 | | | | | | | |
| Comparative | 35.9% | 0.35 | 8.7 | 2.6 | 71% | 0.58 | 106.9% |
| Embodiment 3 | | | | | | | |
| Comparative | 36.8% | 0.66 | 16.9 | 2.5 | 71% | 0.56 | 114.3% |
| Embodiment 4 | | | | | | | |
| Comparative | 34.6% | 0.62 | 12.7 | 2.6 | 73% | 0.60 | 100.0% |
| Embodiment 5 | | | | | | | |
| Comparative | 35.4% | 0.63 | 8.4 | 2.7 | 72% | 0.61 | 96.7% |
| Embodiment 6 | | | | | | | |
| Comparative | 34.4% | 0.88 | 18.0 | 2.5 | 73% | 0.58 | 106.9% |
| Embodiment 7 | | | | | | | |
| Comparative | 35.8% | 0.86 | 12.0 | 2.6 | 73% | 0.62 | 93.5% |
| Embodiment 8 | | | | | | | |
| Comparative | 35.7% | 0.84 | 8.3 | 2.6 | 71% | 0.63 | 90.5% |
| Embodiment 9 | | | | | | | |
| Comparative | 24.2% | 0.35 | 16.8 | 2.5 | 82% | 0.64 | 87.5% |
| Embodiment 10 | | | | | | | |
| Comparative | 25.1% | 0.31 | 12.8 | 2.5 | 83% | 0.66 | 81.8% |
| Embodiment 11 | | | | | | | |
| Comparative | 23.3% | 0.33 | 8.6 | 2.5 | 82% | 0.66 | 81.8% |
| Embodiment 12 | | | | | | | |
| Comparative | 9.9% | 0.65 | 17.3 | 2.6 | 84% | 0.68 | 76.5% |
| Embodiment 13 | | | | | | | |
| Comparative | 10.3% | 0.89 | 17.7 | 2.5 | 82% | 0.67 | 79.1% |
| Embodiment 14 | | | | | | | |
| Comparative | 10.3% | 0.83 | 7.9 | 8.3 | 84% | 0.70 | 69.0% |
| Embodiment 15 | | | | | | | |
| Embodiment 1 | 25.9% | 0.66 | 12.3 | 2.5 | 83% | 0.72 | 66.7% |
| Embodiment 2 | 24.3% | 0.64 | 8.5 | 2.4 | 84% | 0.73 | 64.4% |
| Embodiment 3 | 26.1% | 0.85 | 12.3 | 2.6 | 84% | 0.75 | 60.0% |
| Embodiment 4 | 27.4% | 0.88 | 8.2 | 2.5 | 84% | 0.75 | 60.0% |
| Embodiment 5 | 10.4% | 0.68 | 12.9 | 2.7 | 89% | 0.76 | 57.9% |
| Embodiment 6 | 10.8% | 0.62 | 8.4 | 2.8 | 88% | 0.76 | 57.9% |
| Embodiment 7 | 12.4% | 0.84 | 15.0 | 2.6 | 90% | 0.76 | 57.9% |
| Embodiment 8 | 11.4% | 0.89 | 8.5 | 2.6 | 89% | 0.77 | 55.8% |
| Embodiment 9 | 12.4% | 0.82 | 8.4 | 4.3 | 87% | 0.76 | 57.9% |

As can be seen from the test results in Table 1, when the non-uniformity of the amorphous silicon particles 12 dispersed in the buffer phase 14 does not exceed 30%, the expansion rate of the negative electrode plate 22 can be reduced to a desired level, and the capacity retention rate is relatively high. In other words, by non-crystallizing the silicon particles, the uniformity of the amorphous silicon particles dispersed in the composite particles is improved, thereby helping to improve the uniformity of expansion of the silicon composite particles in all directions, reducing the expansion thickness of the negative electrode, and improving the cycle performance and service life of the electrochemical device.

Further, when the non-uniformity of the amorphous silicon particles 12 dispersed in the buffer phase 14 does not exceed 15%, the expansion rate of the negative electrode plate 22 can be further reduced to a greater extent, and the capacity retention rate is further increased.

With the sphericity of the silicon composite particles 10 being not less than 0.50, the expansion rate of the negative electrode plate 22 can be reduced, and the capacity retention rate can be increased. Controlling the D₉₀−D₁₀ of the negative electrode material 100 to be not greater than 15 μm and controlling the BET specific surface area to be not greater than 5 m²/g help further reduce the expansion rate of the negative electrode plate 22 and increase the capacity retention rate.

The negative electrode material 100 according to this application includes silicon composite particles 10. The silicon composite particles 10 include amorphous silicon particles 12 and a buffer phase 14. The amorphous silicon particles 12 ensure isotropy of the negative electrode material 100 during expansion while ensuring a relatively high volumetric energy density of the electrochemical device 200, thereby avoiding increase in the thickness of the negative electrode plate 22 caused by cracking of the negative electrode material 100. The buffer phase 14 exerts a buffering effect during expansion of the amorphous silicon particles 12.

The foregoing embodiments are merely intended for describing the technical solutions of this application but not intended as a limitation. Although this application is described in detail with reference to the foregoing optional embodiments, a person of ordinary skill in the art understands that modifications or equivalent substitutions may be made to the technical solutions of this application without departing from the spirit and scope of the technical solutions of this application.

What is claimed is:

1. A negative electrode material, comprising silicon composite particles, wherein the silicon composite particles comprise amorphous silicon particles and a buffer phase, the amorphous silicon particles are dispersed in the buffer phase, and a non-uniformity of the amorphous silicon particles dispersed in the buffer phase is less than or equal to 30%.

2. The negative electrode material according to claim 1, wherein the non-uniformity of the amorphous silicon particles dispersed in the buffer phase is less than or equal to 15%.

3. The negative electrode material according to claim 1, wherein a sphericity of the silicon composite particles is greater than or equal to 0.50.

4. The negative electrode material according to claim 1, wherein a specific surface area of the negative electrode material is less than or equal to 5 m²/g.

5. The negative electrode material according to claim 1, wherein a particle size of the negative electrode material satisfies D₉₀−D₁₀≤15 μm.

6. The negative electrode material according to claim 1, wherein the buffer phase comprises at least one of elements of carbon, oxygen, silicon, iron, titanium, aluminum, or cadmium.

7. The negative electrode material according to claim 6, wherein the buffer phase comprises at least one of silicon monoxide or silicon dioxide.

8. The negative electrode material according to claim 1, wherein the silicon composite particles further comprise a conductive agent, and the conductive agent is dispersed in the buffer phase.

9. An electrochemical device, comprising a negative electrode plate, the negative electrode plate comprises a negative active material layer, and the negative active material layer comprises a negative electrode material, wherein the negative electrode material comprises silicon composite particles, the silicon composite particles comprise amorphous silicon particles and a buffer phase, the amorphous silicon particles are dispersed in the buffer phase, and a non-uniformity of the amorphous silicon particles dispersed in the buffer phase is less than or equal to 30%.

10. The electrochemical device according to claim 9, wherein the non-uniformity of the amorphous silicon particles dispersed in the buffer phase is less than or equal to 15%.

11. The electrochemical device according to claim 9, wherein a sphericity of the silicon composite particles is greater than or equal to 0.50.

12. The electrochemical device according to claim 9, wherein a specific surface area of the negative electrode material is less than or equal to 5 m²/g.

13. The electrochemical device according to claim 9, wherein a particle size of the negative electrode material satisfies D₉₀−D₁₀≤15 μm.

14. The electrochemical device according to claim 9, wherein the buffer phase comprises at least one of elements of carbon, oxygen, silicon, iron, titanium, aluminum, or cadmium.

15. The electrochemical device according to claim 14, wherein the buffer phase comprises at least one of silicon monoxide or silicon dioxide.

16. The electrochemical device according to claim 9, wherein the silicon composite particles further comprise a conductive agent, and the conductive agent is dispersed in the buffer phase.

17. An electronic device, comprising an electrochemical device, wherein the electrochemical device comprises a negative electrode plate, the negative electrode plate comprises a negative active material layer, and the negative active material layer comprises a negative electrode material;
wherein the negative electrode material comprises silicon composite particles, the silicon composite particles comprise amorphous silicon particles and a buffer phase, the amorphous silicon particles are dispersed in the buffer phase, and a non-uniformity of the amorphous silicon particles dispersed in the buffer phase is less than or equal to 30%.

18. The electronic device according to claim 17, wherein the non-uniformity of the amorphous silicon particles dispersed in the buffer phase is less than or equal to 15%.

19. The electronic device according to claim 17, wherein a sphericity of the silicon composite particles is greater than or equal to 0.50.

20. The electronic device according to claim 17, wherein a specific surface area of the negative electrode material is less than or equal to 5 m²/g.
